(19) United States
(12) Patent Application Publication
(10) Pub. No.: US 2009/0046202 A1
(43) Pub. Date: Feb. 19, 2009

(54) DE-INTERLACE METHOD AND APPARATUS

(75) Inventors: Ling Shiou Huang, Tainan County (TW); Sheng Chun Niu, Tainan County (TW); Shing Chia Chen, Tainan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: HIMAX TECHNOLOGIES LIMITED, Tainan County (TW)

(21) Appl. No.: 11/840,799

(22) Filed: Aug. 17, 2007

(51) Int. Cl. H04N 7/01

(52) U.S. Cl. 348/441; 348/E07.003

(57) ABSTRACT

A de-interlace method is performed by the following process. First, edge directions of pixels surrounding a target pixel to be interpolated in an interpolating line are received, and a search range selected from the edge directions of the surrounding pixels is determined by checking a consistency of the edge directions of the surrounding pixels. Sequentially, an edge direction of the target pixel is determined based on the search range, and a pixel value of the target pixel is generated based on the edge direction of the target pixel for interpolation.

### BACKGROUND OF THE INVENTION

(A) Field of the Invention

The present invention is related to a method and apparatus for video image processing, and more specifically, to a de-interlace method and apparatus.

(B) Description of Related Art

A frame of an interlaced video is divided into an odd field and an even field. The odd field is displayed on the odd lines of a monitor, and then the even field is display on the even lines thereof, such that a complete frame is displayed.

A de-interlace method converts the interlaced video into a non-interlaced video in order to be displayed by progressive scan mode for better quality. FIG. 1 shows a diagram of an odd field of the interlaced video containing pixel data of odd lines. The de-interlace method generates the pixel data of the even lines according to the pixel data of the odd lines for generating a complete frame. For example, the pixel value of the target pixel M0 on Line 2 can be obtained by interpolation based on the vicinity pixels on Lines 1 and 3. According to a well-known interpolation, M0 can be the average of the upper pixel of Line 1 and the lower pixel of Line 3, along the direction 0.

In addition to the above well-known interpolation, a modified interpolation has been proposed. If the difference between the vicinity pixels along a direction, e.g., one of the directions −2, −1, 1, 0, 1 and 2, is minimum, M0 can be the average of the corresponding vicinity pixels along that direction, which can be called edge direction. For example, if the difference between the pixels along the direction −1 is minimum, M0 can be the average of the pixel data of the pixels P1 and P2, which are positioned along the edge direction −1.

However, the display quality is still not good enough by the conventional de-interlace methods.

### SUMMARY OF THE INVENTION

The present invention provides a de-interlace method and apparatus for video image processing, with a view to increasing the correctness of the pixel interpolation.

In accordance with the de-interlace method of the present invention, edge directions of pixels surrounding a target pixel to be interpolated in an interpolating line are received, and a search range selected from the edge directions of the surrounding pixels is determined by checking a consistency of the edge directions of the surrounding pixels. Sequentially, an edge direction of the target pixel is determined based on the search range, and a pixel value of the target pixel is generated based on the edge direction of the target pixel for interpolation.

Preferably, the surrounding pixels are pixels of a previous interpolated line, pixels in the interpolating line before the target pixel, and/or a pixel in a previous frame corresponding the target pixel.

In an embodiment, the edge direction is determined by calculating differential values between a predicted value of the target pixel and pixel values of the surrounding pixels corresponding to the search range and determining the edge direction of the target pixel based on a minimum of the differential values.

The above de-interlace method can be implemented by a de-interlace apparatus of the present invention comprising a predicted value generator, an edge direction detection device and an interpolating device. The predicted value generator is configured to generate the predicted value of the target pixel. The edge direction detection device is configured to determine the edge direction of the target pixel based on the search range selected from the directions of surrounding pixels of the target pixel by checking a consistency of the directions of the surrounding pixels. The interpolating device is coupled to the predicted value generator and the edge direction detection device and is configured to generate the pixel value of the target pixel based on the edge direction of the target pixel.

### BRIEF DESCRIPTION OF THE DRAWINGS

FIG. 1 illustrates a conventional de-interlace method;

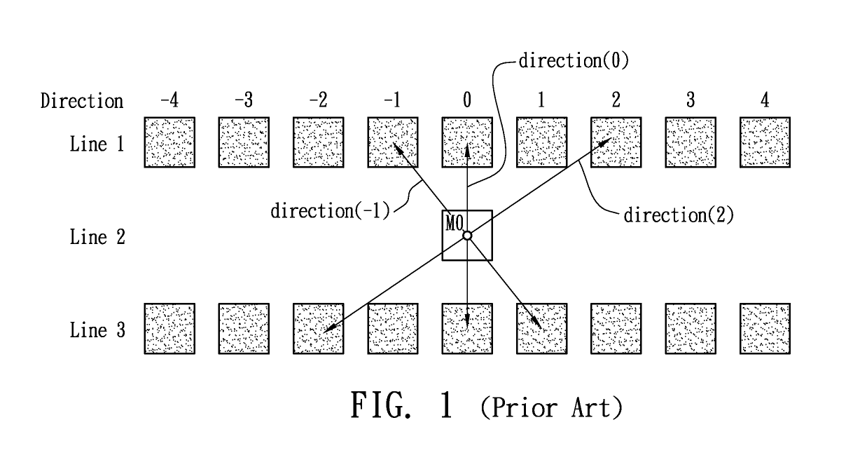

FIG. 2 illustrates a block diagram for a de-interlace apparatus in accordance with the present invention; and

FIG. 3 illustrates a field to be de-interlaced with respect to an embodiment of the de-interlace method in accordance with the present invention.

### DETAILED DESCRIPTION OF THE INVENTION

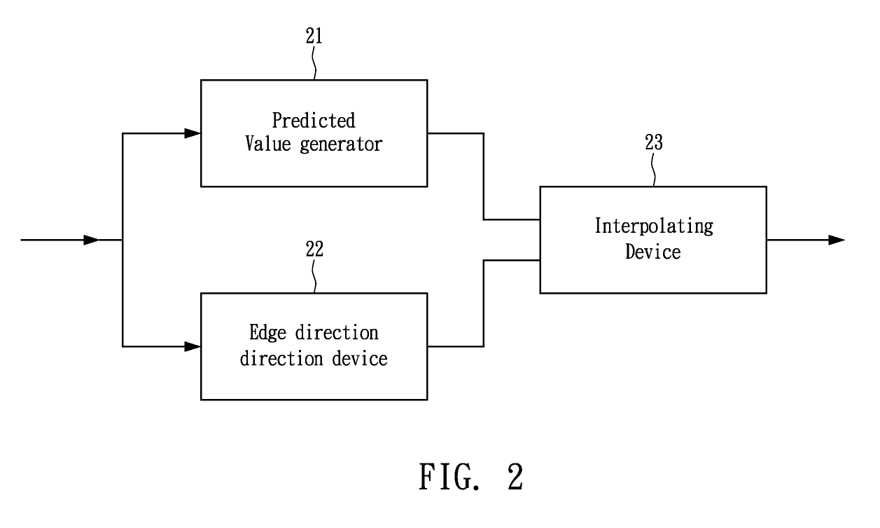

FIG. 2 illustrates a block diagram of a de-interlace apparatus. The de-interlace apparatus 20 includes a predicted value generator 21, an edge direction detection device 22 and an interpolating device 23. The predicted value generator 21 generates a predicted value of the target pixel to be interpolated according to the edge directions of the surrounding pixels. The surround pixels may locate at the current frame or a previous frame. There are ways to predict the value of the target pixel. One way uses an interpolation of the pixels at the upper and lower positions corresponding to the target pixel. The second way uses a surrounding direction analysis.

The surrounding direction analysis analyzes the edge directions of the surrounding pixels corresponding to the target pixel, the surrounding pixels may locate at the current frame or at a previous frame.

The edge direction detection device 22 receives edge directions of pixels surrounding the target pixel, and determines a search range selected from the edge directions of the surrounding pixels by checking a consistency of the edge directions of the surrounding pixels so as to remove less-possible edge direction. The surrounding pixels may locate at the current frame or a previous frame.

Then the edge direction detection device 22 determines an edge direction of the target pixel based on the search range. In the edge direction determination, the edge direction detection device 22 calculates differential values between the predicted value and pixel values of corresponding upper and lower lines of the interpolating line along the edge directions in the search range. The edge direction of the target pixel is determined based on a minimum of the differential values.

The interpolating device 23 interpolates pixel values of pixels at the upper line/lower line along the edge direction of the target pixel to generate the pixel value of the target pixel.

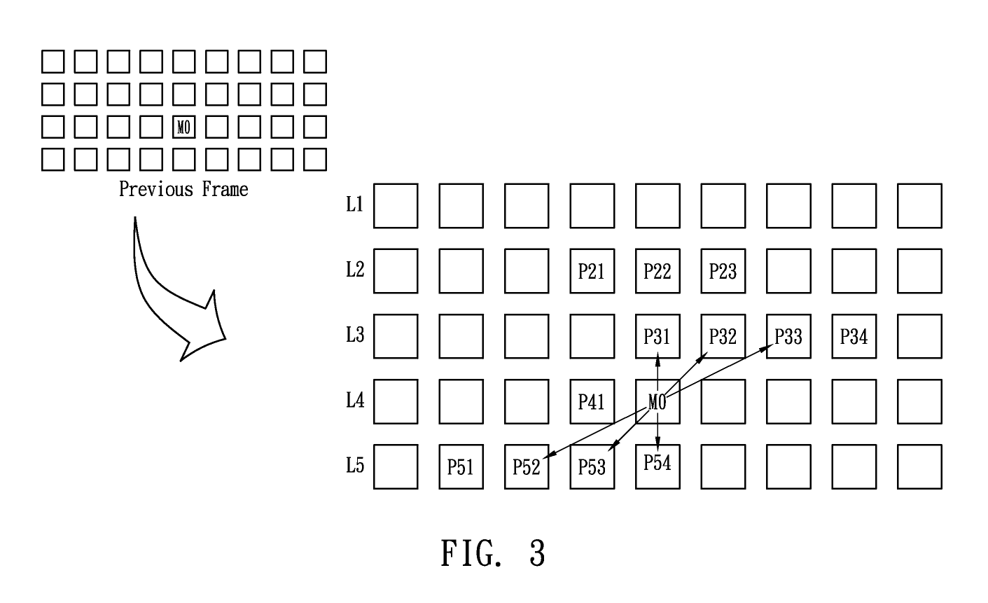

The operation of the de-interlace apparatus 20 is further explained by a field shown in FIG. 3, which illustrates the field to be de-interlaced. Suppose that the field is an odd field and pixels in the odd lines (L1, L3, L5) already have pixel values. The de-interlace apparatus of the embodiment is to calculate pixel values of pixels in the even lines (L2, L4). M0 is the target pixel to be interpolated, and pixel values of the pixels in the even lines L2 and L4 before the target pixel M0 have been calculated by the de-interlace apparatus.

First, the predicted value generator 21 predicts the pixel value of the target pixel M0. There are many ways for the predicted value generator 21 to predict. In one way, the predicted value generator 21 may simply interpolate the pixel values of pixels locate at upper/lower positions corresponding to the target pixel M0. For example, the pixel value of the target pixel M0 equals the average of the pixel values of pixels P31 and P54, located at the upper/lower lines respectively.

In a second way, the predicted value generator 21 may analyze the edge directions of surrounding pixels corresponding to the target pixel M0. For example, the predicted value generator 21 receives the edge directions D21, D22 and D23 of pixels P21, P22 and P23 at a previous interpolated line L2 respectively, and the edge direction D41 of a pixel P41 at the current line L4 located before the target pixel M0. The predicted value generator 21 may also use the edge direction D0 of the target pixel M0 in the previous frame. The predicted value generator 21 may give weightings to each surrounding edge directions to get a predicted direction Dp for the target pixel M0. The predicted value generator 21 may alternatively generate the predicted direction Dp based on a median of the surrounding edge directions. Suppose that D21=0, D22=1, D23=2, D41=3 and D0=3, then the median of these surrounding edge directions are 2, and therefore the predicted direction Dp equals 2. After the predicted direction Dp is generated, the predicted value Pp for the target pixel M0 is calculated. While the predicted direction is 2 from the above example, the predicted value Pp is the interpolation of pixel values of pixel P33 at the upper line L3 and pixel P52 at the lower line L5, along direction 2.

In a third way to calculate the predicted value Pp of the target pixel M0, the predicted value generator 21 first calculate the edge directions of the pixels P31 an P54, which are the upper pixel and lower pixel of the target pixel M0, respectively. Then the average of the edge directions of the pixels P31 and P54 are calculated and used as the predicted edge direction of the target pixel M0. The predicted value Pp of the target pixel M0 is thus calculated according to the predicted edge direction.

After generating the predicted valued Pp of the target pixel M0, the edge direction detection device 22 determines a more accurate edge direction of the target pixel M0. The edge direction detection device 22 first determines the search range by checking the consistency of the edge directions of the surrounding pixels. For example, the search range is set between the maximum and the minimum edge directions of the surrounding pixels. According to the above example, the maximum of the edge directions D_max=max (D21, D22, D23, D41, D0)=3; the minimum of the edge directions D_min=min (D21, D22, D23, D41, D0)=0. Therefore, the search range is between edge direction 0 to edge direction 3, which are all positive and are considered consistent, and other edge directions, such as −1, −2, −3 and etc., are not considered. In another example, suppose (D21, D22, D23, D41, D0)=(−4, 1, 2, 3, 0), the edge direction D21 for pixel P21 is −4 and is located far from the target pixel M0, so the search range is set to 0 to 3. But if pixel P21 is considered close enough to the target pixel M0, the edge direction D21 is also considered.

After the search range is set, the edge direction detection device 22 then calculate differential values between the predicted value Pp of the target pixel M0 and pixel values of corresponding upper and lower lines L3 and L5 of the interpolating line L4 along the directions in the search range. That is, suppose the search rage is 0 to 3, the differential values are:

Diff(direction 3)=(P34−Pp)+(P51−Pp)

Diff(direction 2)=(P33−Pp)+(P52−Pp)

Diff(direction 1)=(P32−Pp)+(P53−Pp)

Diff(direction 0)=(P31−Pp)+(P54−Pp)

Then the edge direction detection device 22 determines the minimum of the differential values, for example Diff (direction 1), and outputs the corresponding direction 1 as the edge direction of the target pixel.

The interpolating device 23 then calculates the pixel value of the target pixel M0 to be the average of pixel values of P32 and P53, while the pixels P32 and P53 are along the direction 1.

The above-described embodiments of the present invention are intended to be illustratively only. Numerous alternative embodiments may be devised by those skilled in the art without departing from the scope of the following claims.

What is claimed is:

1. A de-interlace method comprising:
receiving edge directions of pixels surrounding a target pixel, wherein the target pixel is to be interpolated in an interpolating line;
determining a search range selected from the edge directions of the surrounding pixels by checking a consistency of the edge directions of the surrounding pixels;
determining an edge direction of the target pixel based on the search range; and
interpolating based on the edge direction of the target pixel for generating a pixel value of the target pixel.

2. The de-interlace method in accordance with claim 1, further comprising generating a predicted value of the target pixel.

3. The de-interlace method in accordance with claim 2, wherein the edge direction determining step comprises:
calculating differential values between the predicted value and pixel values of the surrounding pixels corresponding to the search range; and
determining the edge direction of the target pixel based on a minimum of the differential values.

4. The de-interlace method in accordance with claim 1, wherein the surrounding pixels are pixels of a previous interpolated line, pixels in the interpolating line before the target pixel, and/or a pixel in a previous frame corresponding the target pixel.

5. The de-interlace method in accordance with claim 1, wherein the surrounding pixels are pixels in a previous frame.

6. The de-interlace method in accordance with claim 2, wherein the predicted value of the target pixel is generated in response to a predicted direction corresponding to a weighting of the edge directions of the surrounding pixels.

7. The de-interlace method in accordance with claim 6, wherein the predicted value of the target pixel is generated by interpolating pixel values of pixels in a upper line/a lower line along the predicted direction.

8. The de-interlace method in accordance with claim 2, wherein step for generating the predicted value of the target pixel comprises:
generating a predicted direction of the target pixel by interpolating edge directions of a upper pixel and a lower pixel;
generating the predicted value of the target pixel by interpolating pixel values of pixels in a upper line and a lower line along the predicted direction.

9. The de-interlace method in accordance with claim 2, wherein the predicted value of the target pixel is generated in response to a predicted direction being a median of the edge directions of the surrounding pixels.

10. The de-interlace method in accordance with claim 1, wherein the search range includes directions between the maximum and minimum of the edge directions of the surrounding pixels.

11. An apparatus for de-interlace, comprising:
a predicted value generator configured to generate a predicted value of a target pixel to be interpolated in an interpolating line;
an edge direction detection device configured to determine an edge direction of the target pixel based on a search range selected from the directions of surrounding pixels of the target pixel by checking a consistency of the directions of the surrounding pixels; and
an interpolating device coupled to the predicted value generator and the edge direction detection device and configured to generate a pixel value of the target pixel based on the edge direction of the target pixel.

12. The apparatus in accordance with claim 11, wherein the edge direction detection device calculates differential values between the predicted value and pixel values of the surrounding pixels corresponding to the search range so as to determine the edge direction of the target pixel based on a minimum of the differential values.

13. The apparatus in accordance with claim 11, wherein the surrounding pixels are pixels of a previous interpolated line, pixels in the interpolating line before the target pixel, and/or a pixel in a previous frame corresponding the target pixel.

14. The apparatus in accordance with claim 11, wherein the predicted value generator determines a predicted direction corresponding to a weighting of the edge directions of the surrounding pixels for generating the predicted value.

15. The apparatus in accordance with claim 11, wherein the predicted value generator determines a predicted direction corresponding to a median of the edge directions of the surrounding pixels for generating the predicted value.

16. The apparatus in accordance with claim 14, wherein the predicted value generator further interpolates pixel values of pixels in a upper line and a lower line along the predicted direction to generate the predicted value.

17. The apparatus in accordance with claim 11, wherein the search range includes directions between the maximum and minimum of the edge directions of the surrounding pixels.
